(19) United States
(12) Patent Application Publication
(10) Pub. No.: US 2010/0122213 A1
(43) Pub. Date: May 13, 2010

(54) METHOD FOR ASSIGNMENT OF SHORTCUT KEY COMBINATIONS UTILIZING NUMERICAL-SHAPE ASSOCIATION

(76) Inventor: Jen-Te Chen, Shengang Township (TW)

Correspondence Address: JEN-TE CHEN, 2F-2, NO. 471, DAJHOU RD., SHENGANG TOWNSHIP, TAICHUNG COUNTY, 429, TW

(21) Appl. No.: 12/613,655

(22) Filed: Nov. 6, 2009

Related U.S. Application Data
(60) Provisional application No. 61/112,189, filed on Nov. 7, 2008.

(51) Int. Cl. G06F 3/048

(52) U.S. Cl. 715/827

(57) ABSTRACT

A method of assigning shortcut key combinations used to immediately initiate predetermined functions in a computer system, each function associated with at least one representative text. The method is characterized in that a substantial number of the assignments is each based on a numerical-shape association such that a portion of the representative text of the assigned function corresponds to at lease one of the numerical symbols of the assigned shortcut key combinations, wherein said portion does not contain any numerical symbol.

### CROSS-REFERENCE

This application claims priority from U.S. Provisional Patent Application No. 61/112,189, filed on Nov. 7, 2008.

### BACKGROUND OF THE INVENTION

1. Field of Invention

This invention concerns the field of interfaces for computer processing systems, and, in particular, the use of certain key combinations as “shortcuts” to initiate predetermined functions or applications. More particularly, this invention provides shortcuts suitable in devices operating with numeric keypad such as mobile terminals and set-top box with remote control.

2. Description of Related Art

It can be tedious navigating through menu hierarchies or a long list of menu items to find the desired function or application on small screen of mobile terminals and on display operating with remote control remotely as well. Users of these devices can operate more efficiently by utilizing shortcuts. Shortcuts are abbreviated input sequences that are defined to perform the same action as an interaction sequence on a computer system. “Alt” key shortcuts with mnemonics associated with its labels are common practices for personal computer. But in devices operating with numeric keypad, the number of keys becomes a constraint during defining shortcuts and hardly thorough as well as comprehensive associations can be achieved.

FIG. 1 depicts a mobile terminal showing a typical menu 101 after pressing a soft-key 107 of label 111 for menu options in a photo viewer application. Users typically use directional and central keys combo 105 to scroll a highlight 115 and select a desired function from showed menu items. Sub-menu 117 may prompt for more options after selection. Users may again scroll another highlight 119 to do further selection. A scrollbar 121 may be used to indicate availability and location of more items. One of the options 123 with shortcut hints 125 notifies users that a shortcut key ‘0’ on numeral keypad 103 is available for user to immediately initiate the “Start Slideshow” function. Some other menu items with a key bracketed show more shortcuts available. The observation here is that current practices for mobile applications often assign hot keys on numeric keypad 103 somewhat in an arbitrary manner so that it is hard for the users to accommodate. Even if hot key hints are usually provided in menu items for discoverability, users still complain about the constant remembering and forgetting and looking up of shortcut keys. The discoverability provides so far just cannot overcome the hurdle that intensive efforts are required before possessing proficiency skill.

Shortcuts are also utilized for application launch or speed dial. Some application launchers provide several panels containing a handful of application icons as shortcuts. Users are required to navigate through these panels and then visual search for icons to launch. This approach relies on human's spatial memory about objects and a substantial longer time is required to reach the desired locational familiarity. In consequence, users only utilize first panel for frequently used applications and other panels are used like bookshelves for inefficient sequential lookup.

### SUMMARY OF THE INVENTION

One of the objects of the invention is to provide a method of defining a plurality of shortcut key combinations used to immediately initiate specific functions desired by the user in a communication terminal.

One of the objects of the invention is to provide shortcuts with systematic mnemonics that is intuitive and easy to learn on devices operating with numeric keypad.

One of the objects of the invention is to provide methods for assigning application launch shortcut keys in accordance with the numerical-shape association of a portion of the representative text of assigned application.

One of the objects of the invention is to provide a general method of shortcuts assignment such that the shortcut hints can be superimposed on a graphical user interface (GUI) within constrained display area.

To at least achieve the above and other objects, the invention provides a method of assigning shortcut key combinations used to immediately initiate predetermined functions in a computer system, each function associated with at least one representative text, characterized in that a substantial number of the assignments is each based on a numerical-shape association such that a portion of the representative text of the assigned function corresponds to at lease one of the numerical symbols of the assigned shortcut key combinations, wherein said portion does not contain any numerical symbol.

The method provided in the present invention utilizes numerical-shape associations such that a user can interact with a computer system more efficiently because of the reason which will be discussed in more detail in the description of the preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 depicts a mobile terminal showing a typical menu in a photo viewer application.

FIG. 2 depicts the numeral-shape associations and shape intermediates of a preferred embodiment for English letters.

FIG. 3 depicts a demonstrative photo viewer menu with numeral-shape association shortcut hints in the preferred embodiment for English letters.

FIG. 4 depicts the same menu structure as FIG. 3 but with numeral-shape association shortcut hints superimposed in the preferred embodiment for English letters.

FIG. 5 demonstrates comprehensive shortcuts for a demonstrative photo viewer application in consideration of long-press in a preferred embodiment.

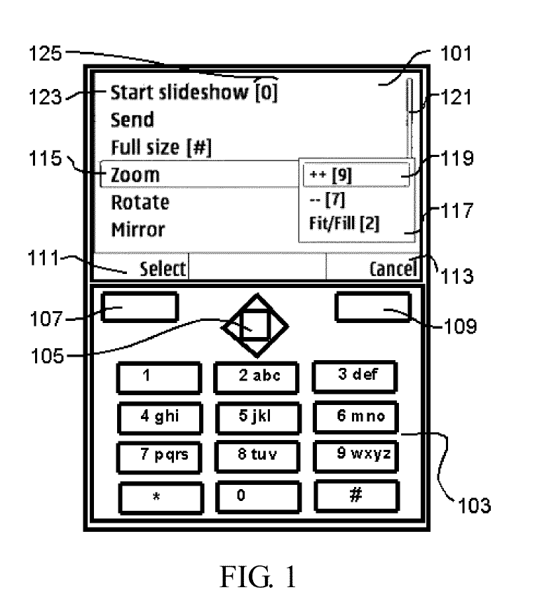

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Current problem of assigning shortcuts key combinations in an arbitrary manner and hurdling users from utilizing efficiently can be resolved by numerical-shape associations disclosed by the invention.

The predetermined functions provided by a computer system typically have some brief descriptions to be displayed on the computer system or be shown on the manual. These brief descriptions and corresponding synonyms stored in the computing system are the representative texts of each associated function. One of the representative texts may be regard as the function name of that function by the designers or users to explicitly indicate it. To facilitate users from remembering shortcut key combinations, a numerical-shape association is provided such that a portion of the representative text of the assigned function corresponds to at lease one of the numerical symbols of the assigned shortcut key combinations, wherein said portion does not contain any numerical symbol. As long as the user can recall a desired function name (a.k.a the representative text of that function), he can immediately associate a numeral with that function and press the correspondent shortcut key to invoke it.

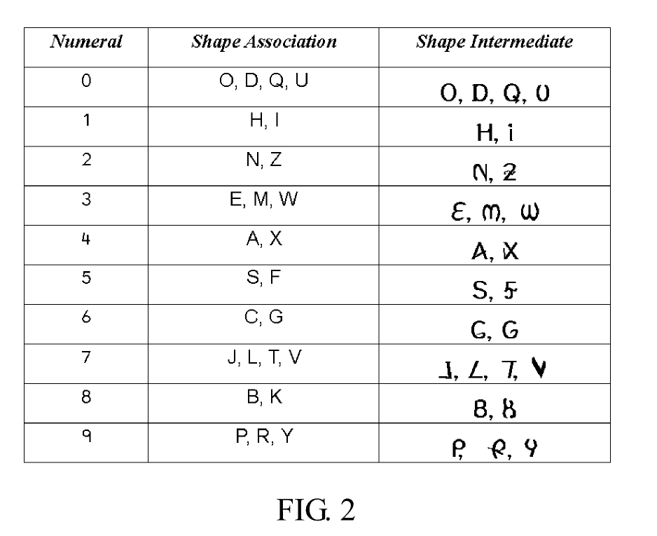

The numerical-shape associations can be constructed based on shape-based mapping disclosed by U.S. Patent Application Publication No. 2008/0266144. Then the numeral that contains most significant shape information of a letter is chosen as the numerical-shape association of that letter. FIG. 2 depicts the numeral-shape associations and shape intermediates of a preferred embodiment for English letters.

Typically, ad hoc or some rule-based methods are used for assignment of keyboard shortcuts during software application development. A systematic way is also disclosed by Hoag (U.S. Pat. No. 6,114,978). To demonstrate current invention without departing from the scope or spirit of the invention, we only utilize the two traditional methods as described by Hoag. Combining with teaching by this invention and consulting FIG. 2, a preferred embodiment for English letters, shortcuts with systematic mnemonics that is intuitive and easy to learn can be provided.

FIG. 2 depicts twenty-six (26) English letters grouping by ten (10) numerals. A “Shape Intermediate” column is provided to facilitate stronger reasoning of the grouping assignments based on numeral-shape associations. To provide a candidate shortcut key combination for this invention, a portion of the representative text of the assigned function is selected, say the first letter for example, then consult the column two of FIG. 2 for this letter, and finally find the corresponding numeral in the same row. This numeral can be a candidate shortcut key combination and the “Shape Intermediate” in the same row may be further used on graphical user interface to help user remember the shortcuts intuitively. There may be some cases that at least two different functions are suggested with the same shortcut key combination. The resolutions can be the same as assigning shortcuts in a traditional personal computer with full keyboard. To prevent key assignment collision, one of the methods is choosing a different representative text. Another one may be choosing different portion of one of the representative texts.

Due to the limited number of assignable keys, the shortcut assignments may base on some rules such as function priority or usage frequency to resolve the confliction.

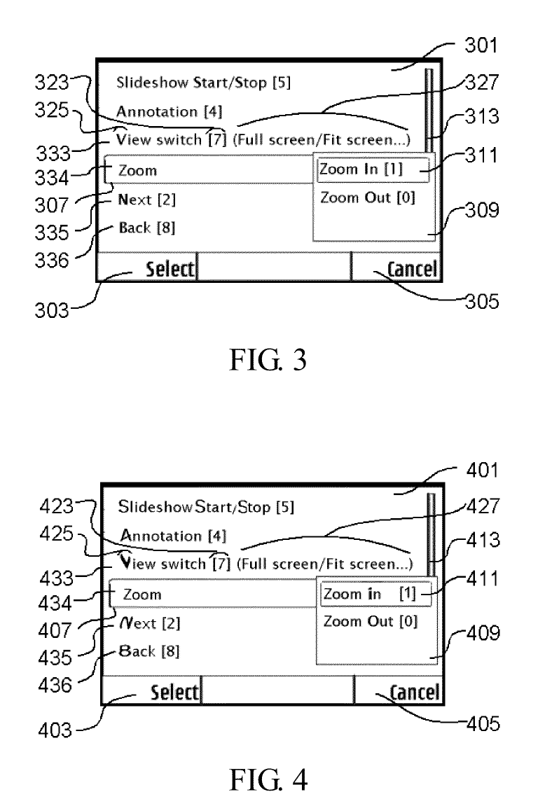

FIG. 3 shows a menu 301 for a photo viewer application with this invention applied. Soft-key labels 303 and 305 are used in conventional way. The menu 301 shows a plurality of menu items such as 333, 334, 335 and 336, wherein item 334 labeled “Zoom” is selected by highlight 307. This selection further prompt a sub-menu 309 with more menu items to be selected by another highlight 311. Take item 333 for example, It shows a representative text “View switch [7] (Full screen/Fit screen . . . )”. The portion 327 of the representative text provides some detailed information and can be omitted if the display area is constrained. The portion 323 shows its shortcut key “7” and corresponds to the letter “V” in the bold portion 325 based on numeral-shape association. Comparing with FIG. 2 of the same field of application, users can easily self-discover the reasoning of shortcut key assignments.

FIG. 4 depicts the same menu structure as FIG. 3 but with numeral-shape association shortcut hints superimposed in the preferred embodiment for English letters. Soft-key labels 403 and 405 are used in conventional way. The menu 401 shows a plurality of menu items such as 433, 434, 435 and 436, wherein item 434 labeled “Zoom” is selected by highlight 407. This selection further prompt a sub-menu 409 with more menu items to be selected by another highlight 411. Take item 433 for example, It shows a representative text “View switch [7] (Full screen/Fit screen . . . )”. The portion 427 of the representative text provides some detailed information and can be omitted if the display area is constrained. The bold portion 425 is an intermediate superimposed by letter “V” and numeral “7”. The portion 423 shows its shortcut key “7” and corresponds to the intermediate 425. Comparing with FIG. 3, users can easily self-discover the reasoning of shortcut key assignments more intuitively by the numeral-shape associations presented. If the users are well understood the shortcut hints taught by the invention, the portion 423 could be further omitted if the display area is constrained.

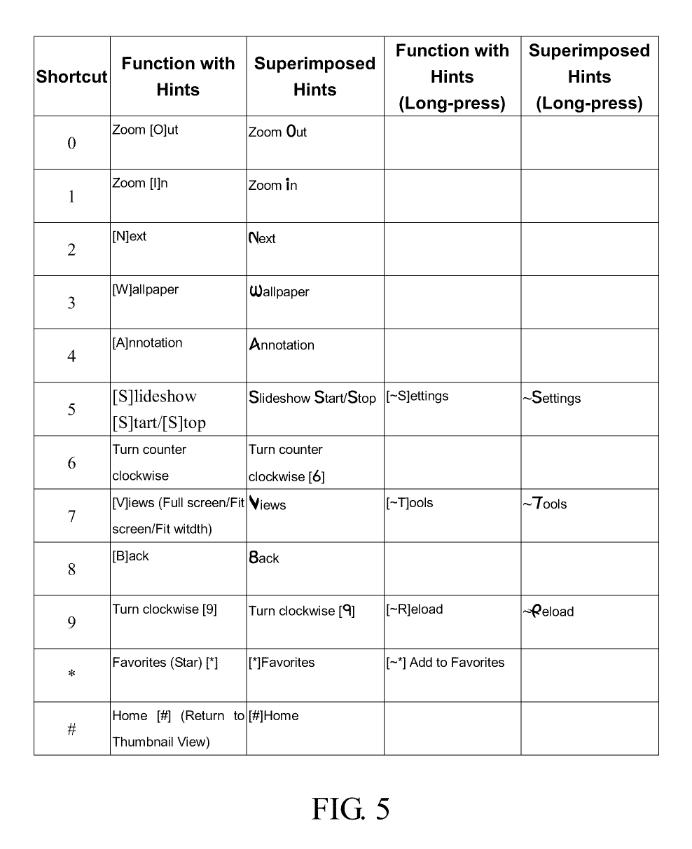

FIG. 5 further demonstrates a more comprehensive preferred embodiment for a demonstrative photo viewer application in consideration of long-press. The first column shows shortcut keys of a typical numerical keypad. The second column labeled “Function with Hints” shows the function description and its selected portion denoted by brackets. The third column shows the numeral-shape association superimposed with function description. The forth and fifth columns are analogous to the second and third columns but considering long-press. The long-press behavior is denoted by the prefixed “˜” symbol. This demonstrates that many functions can still be efficiently and effectively assigned with shortcuts even with numeral keypad.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A method of assigning shortcut key combinations used to immediately initiate predetermined functions in a computer system, each function associated with at least one representative text, characterized in that a substantial number of the assignments is each based on a numerical-shape association such that a portion of the representative text of the assigned function corresponds to at lease one of the numerical symbols of the assigned shortcut key combinations, wherein said portion does not contain any numerical symbol.

2. The said numerical-shape association in claim 1 is further disclosed to the user as mnemonics.

3. The said shortcut key combination in claim 1 contains at least one numerical symbol and the combination can be triggered simultaneously or non-simultaneously.

4. The said portion in claim 1 is indicated on the display to notify the user about the numerical-shape association.

5. The said display in claim 3 can be selected from the group consisting of visual, auditory, tactile, gustatory and olfactory displays.

6. The said indication in claim 3 further comprises an intermediate shape between the said portion and the one or more numerical symbols of the assigned shortcut key combination.

7. The said portion in claim 1 is the first letter of the representative text of the assigned function.

8. The said portion in claim 1 is the first letter of a word of the representative text of the assigned function.

9. The said portion in claim 1 is the first letters of a plurality of words of the representative text of the assigned function.

10. The said predetermined functions in claim 1 contain computer applications.
